(19) United States
(12) Patent Application Publication
(10) Pub. No.: US 2005/0250476 A1
(43) Pub. Date: Nov. 10, 2005

(54) Method for dispatch voice messaging

(76) Inventors: William R. Worger, Gilbert, AZ (US); Matthew D. Fitzpatrick, Poway, CA (US)

Correspondence Address: MOTOROLA, INC., LAW DEPARTMENT, 1303 E. ALGONQUIN ROAD, SCHAUMBURG, IL, 60196, US

(21) Appl. No.: 10/841,104

(22) Filed: May 7, 2004

(51) Int. Cl. H04M 11/10

(52) U.S. Cl. 455/412.1; 455/518

(57) ABSTRACT

For a push-to-talk arrangement in a dispatch call communication system (100), an originator (10) selects a group of called parties (11-14). A push-to-talk server (50) handles a dispatch call in a conventional manner. If all the called parties (11-14) do not respond, the originator is given an option to leave a message for an unavailable party (116). A multimedia message service server (60) is the storage medium for these messages. Any unavailable called subscribers (11-14) are provided an indication of a waiting message (128).

### BACKGROUND OF THE INVENTION

The present invention pertains to a dispatch communication system and more particularly to instant communication with otherwise unavailable communication system users.

Modern day cellular communication systems are providing many different functions for their users. Among these functions is a push-to-talk (PTT) which provides an instant cellular communication between two or more cellular users. Currently the push-to-talk function provides a very fast way to communicate with one or more push-to-talk users.

However, current push-to-talk systems do not provide solutions for situations in which one or more of the called parties is unavailable to take the push-to-talk call in real time. This situation may exist as a result of the users being out of a coverage area, currently being on a standard telephony call, or their hand set is performing a data function such as web browsing. In each of these cases, the busy called party will not receive the intended instant communication.

If some or all of the called parties are unavailable, the calling or originating party typically uses another mechanism to alert the called parties that the calling party wishes to speak to them. Some alternative communication modes might be using standard telephony voice mail or short message services (SMS).

Both of the above mentioned methods are difficult for the calling party. The use of telephony type voice mail involves placing a new call to each of the participants that were unavailable for the real time push-to-talk call. Further, the calling party must then leave each of these called parties a message. For the short message services method, the calling party must type a message, select the called parties that did not participate in the real time push-to-talk call and send the message to these parties. Both of the above mentioned alternate methods take a considerable amount of time and therefore necessarily defeat the purpose of the instant push-to-talk call.

Accordingly, what is needed is a method for a calling party of a push-to-talk communication to get a message to each of the called parties when some or all of the called parties are presently unavailable.

### BRIEF DESCRIPTION OF THE DRAWINGS

FIG. 1 is a block diagram of a cellular communication system in accordance with the present invention.

FIG. 2 is a flow chart of a dispatch voice messaging method in accordance with the present invention.

### PREFERRED EMBODIMENT OF THE INVENTION

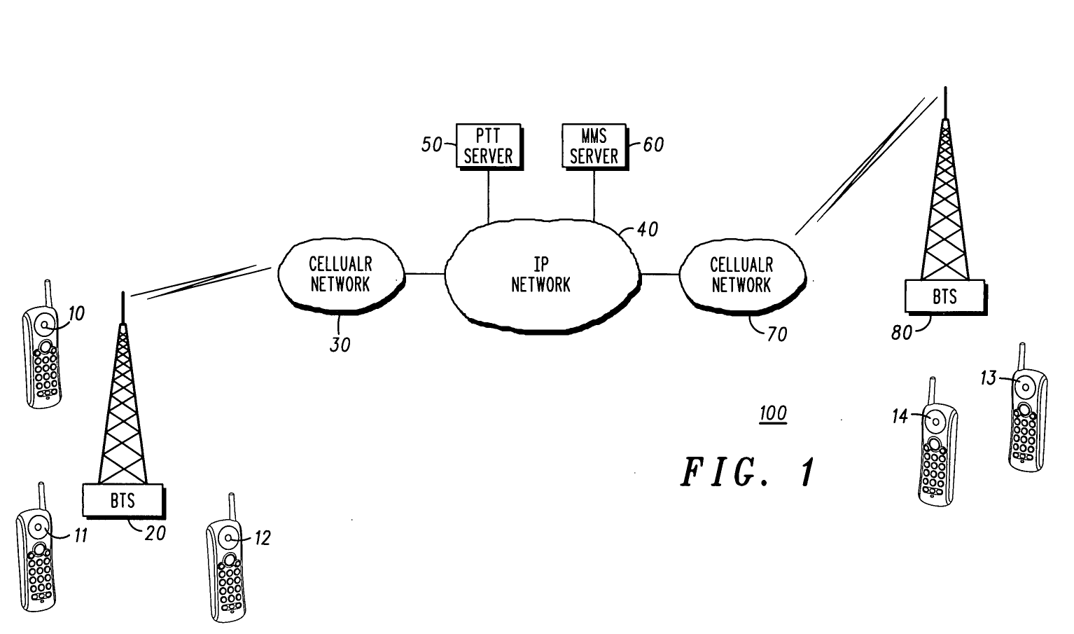

Referring to FIG. 1, a block diagram of a cellular communication system 100 which supports push-to-talk services (PTT) is shown. Several users 10-14 are shown coupled to the cellular communication system 100. For purposes of explanation, names will be used interchangeably with each of the mobile units 10-14. That is, mobile unit 10 represents a subscriber named Sue; mobile unit 12 represents a cellular subscriber Bob; cellular mobile unit 13 represents a cellular subscriber Bill; and mobile unit 14 represents a cellular subscriber Doug.

Cellular communication system 100 includes base station transceiver (BTS) 20 coupled to mobile units 10, 11 and 12. Base station transceiver 20 is coupled to cellular network 30.

Similarly, cellular users Bill 13 and Doug 14 are coupled to base station transceiver 80. Base station transceiver 80 is coupled to cellular network 70.

Cellular network 30 and cellular network 70 are coupled to internet protocol (IP) network 40. Through the internet protocol network 40 the push-to-talk server 50 and the multimedia server 60 are coupled to one another and to the IP network 40.

Once a cellular subscriber, for example Sue 10, selects the push-to-talk function by pressing a push-to-talk button on the handset 10, the push-to-talk server 50 handles and controls the calling arrangement.

In the example depicted in FIG. 1, Sue 10 is the originator or calling party. Sue 10 is attempting to call Ted 11, Bob 12, Bill 13 and Doug 14. Ted 11, Bob 12, Bill 13 and Doug 14 are the called parties. Sue 10 selects via the handset a push-to-talk group that includes Ted, Bob, Bill and Doug. When Sue 10 pushes the push-to-talk button after selecting this group, immediately connection is made from Sue's handset 10 through base station 20, through cellular network 30, through IP network to the push-to-talk server 50. Currently, Bob 12 and Bill 13 are available to answer the push-to-talk call. The PTT server has connected both Bill's handset 13 and Bob's handset 12 in real time with Sue. Sue then delivers a message that there is a meeting in twenty minutes.

Since both Ted 11 and Doug 14 were unavailable to answer Sue's call in real time, they will not get Sue's message about the meeting. Ted 11 may have had his handset in an off-line condition and Doug 14 may have been on a regular telephony call.

At the end of the conversation with Bob 12 and Bill 13, Sue's handset 10 will display an audio or visual indication such as a message “not all group members participated in this call”. Handset 10 will then ask whether Sue wishes to leave a voice message for the members (Ted 11 and Doug 14) which did not participate in the call.

If Sue 10 decides to leave a message, she simply presses and holds the PTT button and leaves a short voice massage for Ted 11 and Doug 14. This message would be similar to the message she left for the called parties Bob 12 and Bill 13. For example, Sue 10 might indicate that there is a meeting in 20 minutes if Ted and Doug can make it. Optionally, Sue may choose not to leave a message since she may realize that unless the message was immediately received, Ted and Doug will not be able to come to the meeting on time.

Sue's message is stored by PTT server 50 in the MMS server 60.

MSS Server 60 may provide a short message service, multi-media message services or packet data services.

When Doug 14 and Ted 11 become available, each will receive an indication on their respective handsets 14 and 11 that a push-to-talk voice message is available and waiting. For Ted 11 and Doug 14 to receive the message, each simply presses and releases the push-to-talk button on their respective handsets 11 and 14. Upon doing this, Sue's message will be played (if it is a voice message) or displayed (if it is a text message) on their handset. Optionally, the message may be stored via MMS server 60 transmitting the message through IP network 40, through cellular network 30 and base station 20 to Ted's handset 11 or through IP network 40 through cellular network 70, through base station 80 to Doug's handset 14. The messages may be stored in these respective handsets 11 and 14 for retrieval by Ted 11 and Doug 14 at later time.

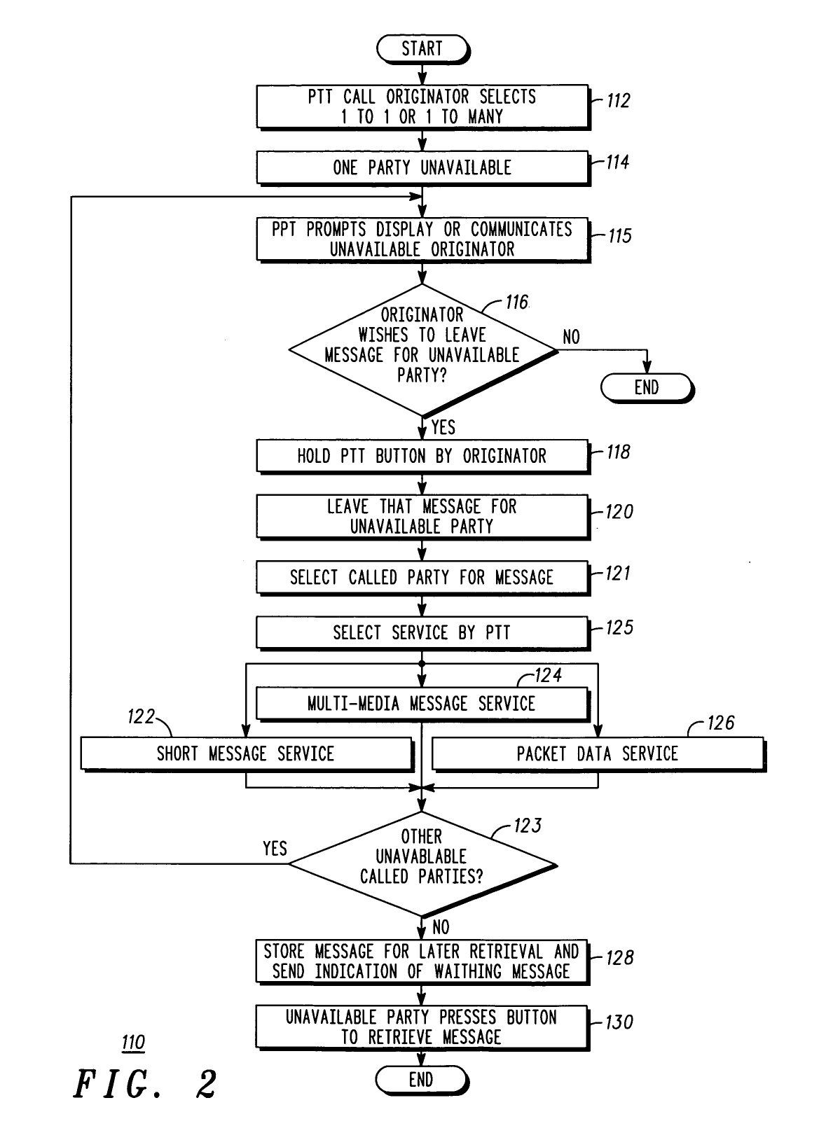

The dispatch voice messaging method described above by example will now be discussed in detail in FIG. 2. Referring to FIG. 2, A flow chart of the dispatch voice messaging method 110 in accordance with the present invention is shown. The method is started and block 112 is entered. The originator selects a push-to-talk call, block 112. This call may be an originator to a single called party or an originator to multiple called parties.

At least one of the called parties is unavailable, block 114. At the end of the originator's call, block 115 prompts via a display or communicates that one or more of the called parties is unavailable. The PTT server 50 will then ask the originator, in this case Sue 10, whether she wishes to leave a message for any of the unavailable called parties, block 116. If the calling party, Sue 10, does not wish to leave a message, block 116 transfers control via the NO path and the process is ended. If the originator (Sue 10) wishes to leave a message for any one of the unavailable called parties, block 116 transfers control to block 118 via the YES path. The originator then holds the push-to-talk button on her handset 10, block 118. This indicates to the push-to-talk server 50 that the originator wishes to leave a short message for an unavailable called party, block 120. Then the originator selects the called party which is to receive the message, block 121.

Next, the push-to-talk server selects the kind of message service to be used to leave messages for the unavailable called parties, block 125. For a short message server to deliver a text message, block 125 transfers control to block 122. Block 122 uses basic short message service to leave a text message for the unavailable called subscriber. The text is created in the PTT Server 50 using a speech to text conversion software, for example.

If a multi-media message service (for delivering voice or video) is selected, block 124 is entered from block 125. The multi-media message service may leave audio or visual indications which are available for the unavailable called subscriber. Lastly, if a packet data service is selected, block 125 transfers control to block 126. Block 126 is entered from block 125 and stores a packet data type message for the unavailable called subscriber. Packet data can be used to send text, video or voice messages. Each of the various message services 122, 124 and 126 then transfers control to block 123.

In block 123 the PTT server 50 determines whether any other called parties 11-14 are unavailable. If not, block 123 transfers control to block 128 via the NO path. If there are other unavailable called parties block 123 transfers control to block 115 to iterate the process of blocks 115 through 123 via the YES path. Finally when all unavailable called parties have been handled in the above manner, block 123 transfers control to block 128 via the NO path.

In block 128, the MMS server 60 provides for storing the message for the short message service server, the multimedia message service server or the packet data service server for later retrieval by the called party. In addition, an indication of a waiting message is sent to the called party, block 128.

Lastly, the unavailable called party may then retrieve the stored message by pressing the push-to-talk button on his handset 11 or 14. The called party may then respond as appropriate. The method is then ended.

In some communication systems, the message may be transferred from the MMS Server 60 to the handset 11 or 14 automatically whenever the handset 11 or 14 is able to accept communications. The user then retrieves the message by pressing the push-to-talk button. The user of the handset 11 or 14 cannot tell when the message was actually transferred to the handset.

As can be seen from the above explanation, the present invention provides a dispatch voice messaging method. A push-to-talk server detects non-responding called parties and asks the originator whether a message should be stored and sent at a later time. If so, the push-to-talk server selects an appropriate message storage server, digitizes and stores the message with the appropriate messaging server. The message server may include a short message service, a multimedia message service or a packet data service. One aspect of the present method is that a push-to-talk server may directly employ voice messaging without causing the originating user to interact with a separate communication service. Another advantageous feature of this method is that only those members of a dispatch call group that were unavailable to take the real time dispatch call are selected for stored message services. Those able to take the call are instantly connected and receive the originator's message in real time.

Although the preferred embodiment of the invention has been illustrated, and that form described in detail, it will be readily apparent to those skilled in the art that various modifications may be made therein without departing from the spirit of the present invention or from the scope of the appended claims.

1. In a mobile communication system, a messaging method for a dispatch call, the messaging method comprising the steps of:
originating the dispatch call by an originator to at least one called party through the mobile communication system;
determining by the mobile communication system whether the at least one called party is unavailable for the dispatch call; and
if the at least one called party is unavailable, storing by the mobile communication system a message for the at least one called party.

2. In a mobile communication system, a messaging method as claimed in claim 1, wherein there is further included steps of:
determining whether there are other unavailable called parties; and
if there are other unavailable third parties, iterating the step of storing by the mobile communication system the message.

3. In a mobile communication system, the messaging method as claimed in claim 1, wherein there is further included a step of providing an indication by a push-to-talk server to a mobile unit that the at least one called party is unavailable.

4. In a mobile communication system, the messaging method as claimed in claim 3, wherein there is further included a step of prompting by the push-to-talk server the originator to determine whether the originator is storing a message for the at least one called party which is unavailable.

5. In a mobile communication system, the messaging method as claimed in claim 4, wherein there is further included a step of responsive to the step of prompting by the push-to-talk server, indicating by the originator to the push-to-talk server that the message for the at least one called party which is unavailable is to be stored.

6. In a mobile communication system, the messaging method as claimed in claim 5, wherein responsive to the step of indicating by the originator there is further included a step of providing the message for storage by the originator to a messaging server for the at least one called party which is unavailable.

7. In a mobile communication system, the messaging method as claimed in claim 6, wherein there is further included a step of selecting by the push-to-talk server a short message service server as the messaging server.

8. In a mobile communication system, the messaging method as claimed in claim 6, wherein there is further included a step of selecting by the push-to-talk server a multimedia message server as the messaging server.

9. In a mobile communication system, the messaging method as claimed in claim 6, wherein there is further included a step of selecting by the push-to-talk server a packet data service server as the messaging server.

10. In a mobile communication system, the messaging method as claimed in claim 6, wherein there is further included a step of indicating by the push-to-talk server to the unavailable called party that a message is waiting.

11. In a mobile communication system, the messaging method as claimed in claim 10, wherein there is further included a step of retrieving from the messaging server the stored message by the at least one called party which is unavailable.

12. In a mobile communication system, the messaging method as claimed in claim 11, wherein there is further included a step of iterating the steps of claims 3 through 11 for a plurality of unavailable called parties.

13. A dispatch call voice messaging method comprising the steps of:
originating a dispatch call by an originator to a plurality of called parties;
indicating by a dispatch server that at least one of the plurality of called parties is unavailable to take the dispatch call in real time; and
storing a message with a messaging server in real time by the originator for the at least one unavailable called party of the plurality of called parties.

14. The dispatch call voice messaging method as claimed in claim 13, wherein there is further included a step of determining by the dispatch server whether the originator is storing the message in real time for the at least one unavailable called party.

15. The dispatch call voice messaging method as claimed in claim 14, wherein there is further included a step of indicating by the originator that the message is to be sent to the dispatch server in real time for the at least one unavailable called party.

16. The dispatch call voice messaging method as claimed in claim 15, wherein there is further included a step of storing in real time by the messaging server the message of the originator.

17. The dispatch call voice messaging method as claimed in claim 16, wherein there is further included a step of indicating in real time by the dispatch server to the at least one unavailable called party that a message is waiting.

18. The dispatch call voice messaging method as claimed in claim 17, wherein there is further included a step of retrieving the message at a later time by the at least one unavailable called party.

19. In a dispatch communication system, a dispatch voice messaging method comprising the steps of:
originating by a calling party a dispatch call to at least one of a plurality of called parties;
indicating in real time to the calling party by a dispatch server any unavailable called party of the plurality of called parties which failed to respond to the dispatch call;
storing in real time a message with a messaging server for any unavailable called party of the plurality of called parties; and
sending by the dispatch server an indication of a waiting message stored with the messaging server to any unavailable called party.

20. In a dispatch communication system, a dispatch voice messaging method as claimed in claim 19, wherein there is further included a step of retrieving the waiting message by any unavailable called party, said retrieving not being performed in real time.
